(19) United States
(12) Patent Application Publication
(10) Pub. No.: US 2008/0274726 A1
(43) Pub. Date: Nov. 6, 2008

(54) Testing a Receiver of Wireless Messaging Device

(76) Inventor: Juha Simola, Turku (FI)

Correspondence Address: HOFFMANN & BARON, LLP, 6900 JERICHO TURNPIKE, SYOSSET, NY, 11791, US

(21) Appl. No.: 10/586,714

(22) PCT Filed: Jan. 28, 2005
(86) PCT No.: PCT/FI05/00061

§ 371 Date: Jun. 25, 2008

(30) Foreign Application Priority Data
Jan. 30, 2004 (FI) 20040138

(51) Int. Cl. H04Q 7/34; H04B 17/00

(52) U.S. Cl. 455/423; 455/67.14

(57) ABSTRACT

The invention relates to a method, system and computer program for testing a wireless messaging device in a mobile communication system. The invention comprises generating test signal which contains physical time-slots, at least one of which is allocated for transmission of system information from a base transceiver station of the mobile communication system to the messaging device; and positioning a synchronization sequence supported by the mobile communication system in a time-slot allocated for transmission of system information. The presented solution increases the average power of the signal part used in synchronization, shortening the time used for the synchronization and thus improving the performance of the test line.

### FIELD

The invention relates to a method, system and computer program for testing a wireless messaging device.

### BACKGROUND

Testing wireless messaging devices, such as mobile phones, of mobile communication systems plays an important role in production processes and maintenance of wireless messaging devices. One crucial testing step involves testing and characterizing the performance of a receiver of a wireless messaging device.

A receiver of a wireless messaging device can be tested by generating a test signal in a test simulator emulating a base transceiver station of a mobile communication system, the test signal being supplied to a receiver. The test signal typically contains synchronization sequences with which the receiver is synchronized with the received signal. After the synchronization, the receiver can receive a test sequence by means of which the receiver can be characterized.

The time used for the synchronization plays an important part in testing a receiver of a wireless messaging device. Thus, it is worthwhile to examine techniques with which the time used for the synchronization can be shortened.

### BRIEF DESCRIPTION

An object of the invention is to implement a method, system and computer program with which the testing time of a receiver of a mobile messaging device can be shortened. This is achieved with a method for testing a receiver of a wireless messaging device in a mobile communication system, comprising generating a test signal which contains physical time-slots, at least one of which is allocated for transmission of system information from a base transceiver station of the mobile communication system to the messaging device; and positioning a synchronization sequence supported by the mobile communication system in a time-slot allocated for transmission of system information.

An object of the invention is also a system for testing a receiver of a wireless messaging device in a mobile communication system, comprising a test-signal generator for generating a test signal, which test signal contains physical time-slots, at least one of which time-slots is allocated for transmission of system information from a base transceiver station of the mobile communication system to the messaging device, the test-signal generator being configured to position a synchronization sequence supported by the mobile communication system in a time-slot allocated for the transmission of system information.

An object of the invention is also a computer program for executing a computer process for testing a receiver of a wireless messaging device in a mobile communication system, the computer process comprising the steps of: receiving as input a test signal containing physical time-slots, at least one of which is allocated for transmission of system information from a base transceiver station of the mobile communication system to the messaging device, a synchronization sequence supported by the mobile communication system being positioned in the time-slot; identifying the synchronization sequence from the test signal; and synchronizing the receiver by means of the synchronization sequence.

Preferred embodiments of the invention are described in the dependent claims.

A plurality of advantages is achieved with the method and system according to the invention. Positioning the synchronization sequence in a time-slot allocated for transmission of system information increases the time average of the power of the synchronization sequence, whereby the synchronization becomes faster and more reliable. This results in the increased performance of the test line of messaging devices.

### LIST OF FIGURES

The invention will now be explained in greater detail in connection with preferred embodiments, with reference to the attached drawings, of which

FIG. 1 shows an example of the structure of a test system;

FIG. 2 shows an example of the structure of a test-signal generator of a test system;

FIG. 3 shows an example of the structure of a radio frequency unit of a test system;

FIG. 4A shows an example of a test signal according to prior art;

FIG. 4B shows an example of a test signal according to an embodiment;

FIG. 5A shows another example of a test signal according to prior art;

FIG. 5B shows an example of a test signal according to an embodiment;

FIG. 6 shows a method flow chart in accordance with some embodiments of the invention;

FIG. 7 shows a method flow chart in accordance with some embodiments of the invention; and

FIG. 8 shows a method flow chart in accordance with some embodiments of the invention.

### DESCRIPTION OF EMBODIMENTS

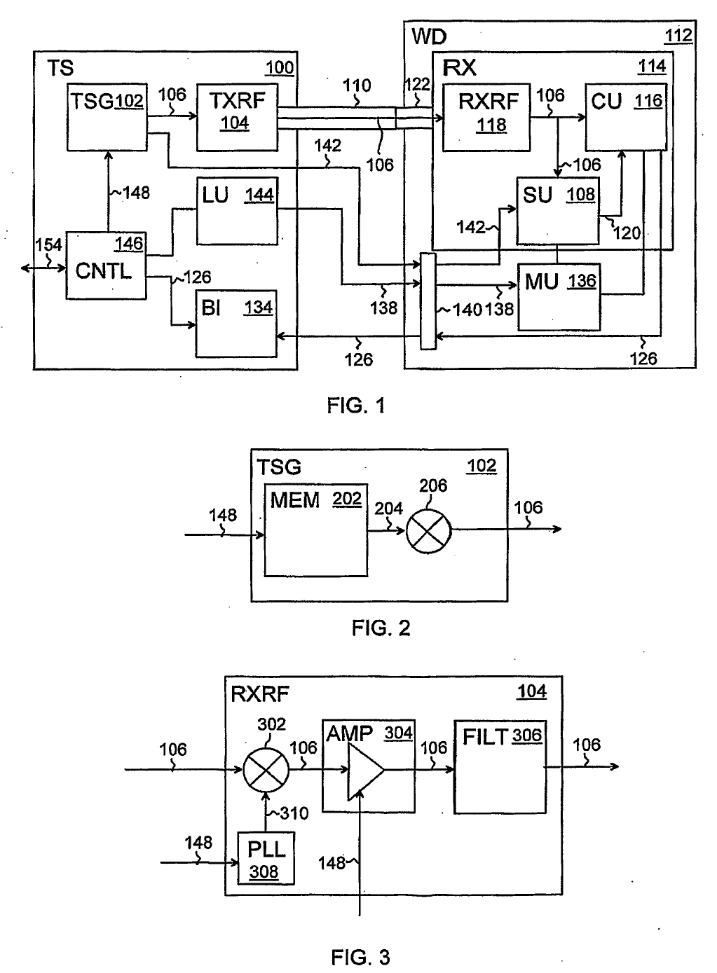

Referring to the example of FIG. 1, a test system 100 according to the presented solution comprises a test-signal generator 102 for generating a test signal 106 for testing a receiver 114 of a wireless messaging device 112 in a mobile communication system. The test signal 106 generated by the test-signal generator 102 may be, for instance, a digital baseband signal.

One task of the test system 100 is to generate a test signal 106, with which a signal of a mobile communication system is simulated under controlled conditions. Thus, some properties of the test signal 106, such as the frequency and frame structure, are typically in accordance with a mobile communication system standard, such as the GSM (Global System for Mobile Communications) standard.

The wireless messaging device 112 is typically an electronic device manufactured in large-scale production, the device comprising a radio receiver and communicating with base transceiver stations of the mobile communication network via a radio link. The wireless messaging device 112 may be, for example, a mobile phone, radio modem or portable computer. The solution is not, however, limited to the presented examples.

In testing the receiver 114 of the wireless messaging device 112, it is typically the sensitivity, noise tolerance and noise figure of a radio frequency part 118 that are characterized. In addition, the testing may include calibration of the receiver 114, adjustment of the receiving amplitude and/or creation of a calibration table. The solution is not, however, limited to the presented measures but can be used to characterize any part of the receiver chain of the wireless messaging device 112. The testing may be performed for instance in the production and/or maintenance stage of the wireless messaging device 112.

The radio frequency part 118 of the wireless messaging device 112 typically comprises a radio frequency filter, low noise amplifier, down-converter and demodulator.

In one embodiment, the test system 100 comprises a radio frequency unit 104 which converts the test signal 106 to the radio frequency used by the mobile communication system. The radio frequency may be selectable from GSM carrier frequencies, for instance. In one embodiment, the radio frequency unit 104 is integrated as a part of the test-signal generator 102.

FIG. 1 also shows a transmission line 110, with which the test signal 106 is supplied to the receiver 114. The transmission line 110 may be, for example, a coaxial cable connected to an antenna connector 122 of the messaging device 112. In such a case, the test signal 106 can be supplied with relatively small transmission losses and transmission interferences to the receiver 114 of the messaging device 112, whereby accurate characterization of the receiver 114 is achieved with the test system 100.

In one embodiment, the test system 100 comprises a control unit 146 which controls the test-signal generator 102. The control unit 146 can, for example, transmit to the test-signal generator 102 a test command signal 148, which starts in the test-signal generator 102 a test sequence, in which the test signal 106 is generated and transmitted to the wireless messaging device 112.

The control unit 146 can, in addition, transmit and/or receive control signals 154 from the outside of the test system 100. By means of control signals 154, a test sequence can be initiated or the test system can be informed that the wireless messaging device 112 is ready for testing, for instance. With control signals 154 the test result can also be made known outside the test system 100.

The control unit 146 may comprise memory means, such as random access memory (RAM), read-only memory (ROM) or a hard disk. Further, the control unit 146 may comprise a digital processor and computer programs. In one embodiment, the control unit 146 is integrated into the control unit of a larger test system, which comprises also testing of functional units other than the receiver 114.

Referring to the example of FIG. 2, the test-signal generator 102 may comprise a memory unit 202 and a modulator 206 connected to the memory unit 202. A bit string 204 contained in the synchronization sequence supported by the mobile communication system may be stored in the memory unit 202, which bit string is modulated in the modulator 206. As a result, a baseband test signal 106 is generated, having a waveform according to a modulation method, such as GMSK (Gaussian Minimum Shift Keying). The bandwidth of the waveform may be, for instance, to 300 kHz, but the presented solution is not limited to this bandwidth. Referring to the example of FIG. 3, the radio frequency unit 104 comprises an up-converter 302, which converts the baseband test signal 106 to radio frequency with, for example, a radio frequency signal 310 received from a phase-locked loop 308.

The phase-locked loop 308 may receive the test command signal 148 with which the frequency of the radio frequency signal 310 generated by the phase-locked loop and thus the frequency of the carrier wave of the test signal 106 are determined.

The test signal 106 may be further supplied to an amplifier unit 304, in which the test signal 106 is amplified to the desired power. The power control may be performed, for instance, controlled by the test command signal.

In one embodiment of the invention, the radio frequency unit 104 comprises a radio frequency filter 306, for example to attenuate the detrimental signal components generated in the up-conversion.

Still referring to FIG. 1, the radio frequency part 118 of the wireless messaging device 112 may convert the radio-frequency test signal 106 to the baseband and supply the baseband test signal 106 to a characterization unit 116. The characterization unit 116 analyzes the test signal 106 by determining for instance the signal level and/or noise level of the test sequence positioned in the test signal 106.

Prior to the characterization of the test signal 106, part of the test signal 106 is supplied to the synchronization unit 108. The synchronization unit 108 identifies the synchronization sequence of the test signal 106 and generates a synchronization signal 120 by means of the synchronization sequence. The synchronization signal 120 is supplied to the characterization unit 116, which synchronizes with the test signal 106 and is capable of identifying the test sequence and other required parts from the test signal 106 to characterize the receiver 114.

The synchronization is typically performed by correlating the synchronization sequence of the test signal 106 with a reference sequence pre-programmed in the messaging device 112, which reference sequence may be identical with the synchronization sequence. If the synchronization sequence is supported by the mobile communication system, the reference sequence may have been stored in advance in the memory 136 of the messaging device 112.

As a result of the characterization of the receiver 114, the characterization unit 116 generates a variable characterizing the receiver 114, such as the bit error rate (BER). In one embodiment of the invention, the characterization unit 116 generates a signal 126 containing the variable characterizing the receiver 114, the signal being outputted in a digital form to an external bus 140 of the messaging device 112. The external bus 140 may be the rear connector of the messaging device 112, for example.

In one embodiment, the test system 100 comprises a connection unit 134 via which the test system 100 can be connected to the external bus 140 of the messaging device 112, for example. The connection unit 134 may receive the signal 126 that contains the variable characterizing the receiver 114 and transmit the signal 126 or part of the signal to the control unit 146 of the test system 100.

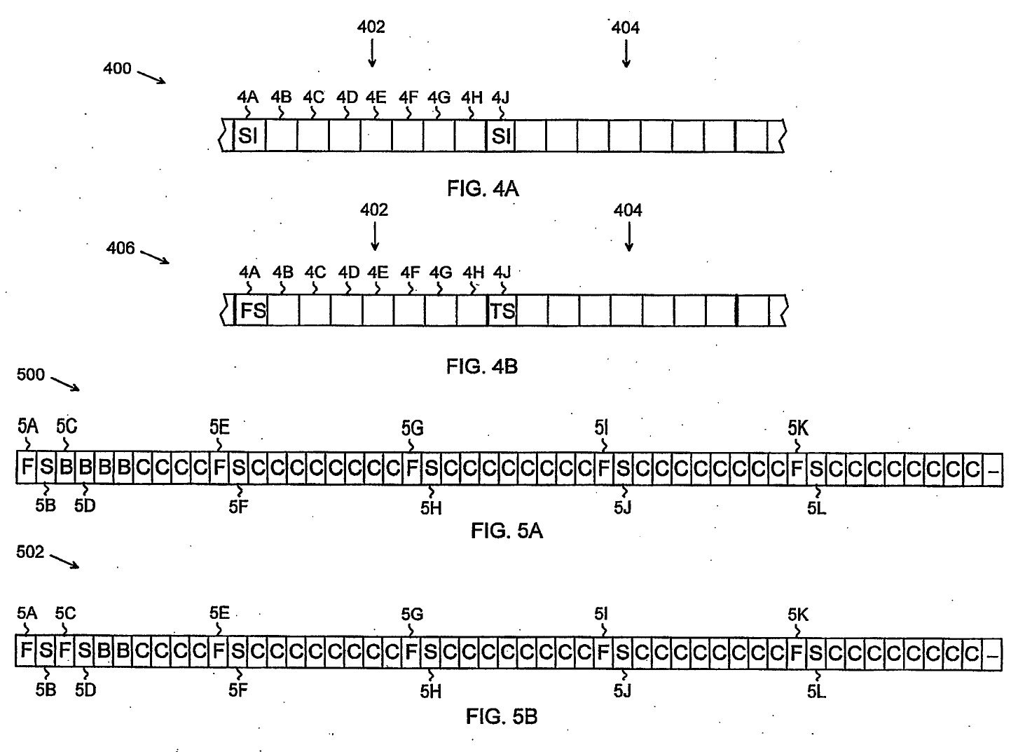

Referring to FIG. 4A, a frame structure 400 is examined as an example, the structure comprising at least two 8-time-slot frames 402 and 404, the boundaries of which are indicated with vertical lines. The example shows physical time-slots 4A to 4H of the frame 402. As for the frame 404, the 0 time-slot, i.e. the first time-slot 4J of the frame structure, is indicated, the time-slots being numbered from 0 to 7. Burst-like output, such as a GSM burst, can typically be positioned in each physical time-slot 4A to 4J.

The time-slots 4A and 4J of the test signal 400 are allocated on the basis of the system standard of the mobile communication system, such as the GSM system, for transmission of system information (SI) from a base transceiver station to the wireless messaging device. System information is typically formed of parameters of the mobile communication system by means of which the wireless messaging device 112 executes required functions in a desired manner when connected to the mobile communication system. Such functions may be crossover and selection of the radio frequency, for instance. One difference between the synchronization sequence and system information is that the synchronization sequence does not contain information in a parameter form, the transmission of information being typically based on a predetermined order of bits. Further, processing synchronization sequences does not require transmission of system information before the synchronization sequence, because the processing of synchronization sequences takes place on the basis of instructions pre-programmed in the wireless messaging device. The test signal 400 may further contain synchronization sequences in time-slots according to the system standard.

In one embodiment, the time-slot 4A, 4J allocated for transmission of system information is the time-slot of the broadcast control channel (BCCH) of the GSM system, which is typically the 0 time-slot in an 8-time-slot frame structure. In another embodiment, also the 1 time-slot, i.e. for instance the time-slot 4B, is allocated for the BCCH channel in accordance with the GSM specification.

Referring to the example of a frame structure 406 in FIG. 4B, a synchronization sequence (FS, TS) supported by the mobile communication system is positioned in the time-slot 4A, 4J allocated for transmission of system information. In this case, the average power of the synchronization signal has increased in relation to the test signal 400 of FIG. 4A, and thus the time spent for the synchronization has been shortened in relation to the time achieved with the test signal 400.

The synchronization sequence (FS, TS) can be positioned in the time-slot 4A, 4J allocated for transmission of system information by, for instance, pointing at the memory space of the memory unit 202 of the test-signal generator 102 in such a way that the bit string 204 of the synchronization sequence is positioned in the desired time-slot 4A, 4J. The timing may take place on the basis of the test command signal 148 of the control unit 146.

The memory unit 202 may contain a sequence library, from which the desired synchronization sequence is picked up by supplying the index of the desired sequence, for example, to the memory unit 202. The corresponding sequences of the sequence library may be pre-stored also in the memory 136 of the wireless messaging device 112.

In one embodiment, a frequency synchronization sequence (FS) supported by the mobile communication system is positioned in the time-slot 4A allocated for transmission of system information. In this case, a frequency synchronization sequence bit string 204 is outputted from the memory unit 202 of the test-signal generator 102. The radio frequency part 118 of the wireless messaging device 112 receives a test signal 106, and the synchronization unit 108 of the receiver 114 identifies the frequency synchronization sequence from the test signal 106. After this, the synchronization unit 108 frequency-synchronizes the receiver 114 by means of the frequency synchronization sequence. The bits of the frequency synchronization sequence bit string 204 are zero bits, for example, in which case the test signal 106 outputted by the radio frequency part 118 includes sinewave, by means of which the synchronization unit 118 performs the frequency synchronization by checking its own timing, for instance. As a result of the frequency synchronization, the receiver 114 can identify and demodulate also other parts, such as time-slots included in a time synchronization sequence, from the test signal 106.

In one embodiment, the frequency synchronization sequence comprises bits of the training sequence code of a frequency synchronization channel (FCCH) according to the GSM standard, these bits being typically zeros. The number of bits may be 148, for example. In this case, an FCCH channel is positioned in the time-slot of the BCCH channel. This corresponds to a BCCH burst being replaced with an FCCH burst in the test signal 106.

In one embodiment, a time synchronization sequence (TS) supported by the mobile communication system is positioned in the time-slot 4A, 4J allocated for transmission of system information. In this case, a time synchronization sequence bit string 204 is outputted from the memory unit 202 of the test-signal generator 102. The radio frequency part 118 receives the test signal 106, and the synchronization unit 108 identifies the time synchronization sequence from the test signal 106 by using, for instance, results received from frequency synchronization, such as information on the relative positions of the time-slots. It is to be noted that in this case the frequency synchronization sequence may have been identified by means of a frequency synchronization sequence other than the one in the presented solution. This other frequency synchronization sequence may be a frequency synchronization sequence that becomes positioned in the frame structure in accordance with the messaging system standard. Subsequently, the synchronization unit 108 time-synchronizes the receiver 114 with the time structure of the test signal 106, such as with bits and/or the frame structure, by means of a time synchronization sequence, and possibly receives information on the numbers of the frames and time-slots, to be transmitted in the test signal 106, in a multi-frame structure.

In one embodiment, the time synchronization sequence comprises a synchronization channel (SCH) according to the GSM standard. The number of bits may be 64, for instance. In this case, an SCH channel is positioned in the time-slot of the BCCH channel. This corresponds to a BCCH burst being replaced with an SCH burst in the test signal 106.

In one embodiment, the frequency synchronization sequence (FS) and the time synchronization sequence (TS) are positioned in the test signal 106 in such a way that the interval between the time-slot 4A included in the frequency synchronization sequence and the time-slot 4J included in the time synchronization sequence is 8 time-slots, counted from the front edge of the time-slots. The front edges of the time-slots 4A and 4J are indicated with a bold vertical line. The presented interval between the time-slots 4A and 4J corresponds to the time-slot 4A that contains a frequency synchronization sequence and the time-slot 4J that contains a time synchronization sequence being positioned at same points in the 8-time-slot frame structure. Thus, the time-slot 4J containing a time synchronization sequence can be identified on the basis of the position of the time-slot 4A containing a time synchronization sequence, for instance premised on the GSM standard.

In one embodiment, the test-signal generator 102 transmits a synchronization signal 142 to the synchronization unit 108 via the external bus 140, by means of which synchronization signal the receiver 114 is partly synchronized. The synchronization signal 142 may contain a frequency synchronization sequence, for example. In such a case, the test signal 106 may contain a time synchronization sequence according to the presented solution.

Referring to the example of FIG. 5A, the test signal 106 may contain at least one 51-frame multi-frame 500, in which elements, such as elements 5A to 6L, are 8-time-slot TDMA (Time Division Multiple Access) frames. The structure of the elements 5A to 5L may be similar to that of the frames 402, 404 in FIG. 4A. The frames are named on the basis of the channel transmitted in the 0 time-slot, using the channels of the GSM standard as follows:

F=TDMA frame including a frequency synchronization channel (FCCH);
S=TDMA frame including a synchronization channel (SCH);
C=TDMA frame including a common control channel (CCCH);
B=TDMA frame including a broadcast control channel (BCCH).

In the example of FIG. 5B, synchronization sequences are positioned in time-slots allocated for transmission of system information in a 51-frame multi-frame 502 in such a way that an FCCH channel is positioned in a time-slot allocated for the BCCH channel of the frame of an element 5C. In addition, an SCH channel is positioned in the time-slot allocated for a BCCH channel, in the frame of an element 5D. Further, an SCH channel is positioned in the time-slot allocated for a BCCH channel, in the frame of an element 5D. In this case, the number of synchronization sequences in a 51-frame multi-frame has changed from 10 to 12. It is also feasible, in accordance with the invention, that either an FCCH channel or an SCH channel is positioned in only one of the time-slots allocated for a BCCH channel, whereby the number of synchronization sequences in a modified 51-frame multi-frame is at least 11.

Referring to FIG. 1 again, in one embodiment the test system 100 comprises a loading unit 144 for loading a computer program to a wireless messaging device 112. The computer program executes a computer process by means of which the wireless messaging device 114 is configured to use the test signal 106 according to the presented solution. In a computer process, the wireless messaging device 114 receives the test signal 106 as input, identifies the synchronization sequence from the test signal 106 and synchronizes the receiver 112 by means of the synchronization sequence.

The loading unit loads a computer program from the memory means of the control unit 146, for example, and transmits a signal 138 containing the computer program to the external bus 140 of the messaging device 112, for example. From the external bus, the signal is transmitted to the memory 136 of the messaging device 112, which memory is, for instance, FLASH memory. The required parts of the computer program or the control commands corresponding to the parts are transmitted from the memory 136 to the synchronization unit 108 and the characterization unit 116.

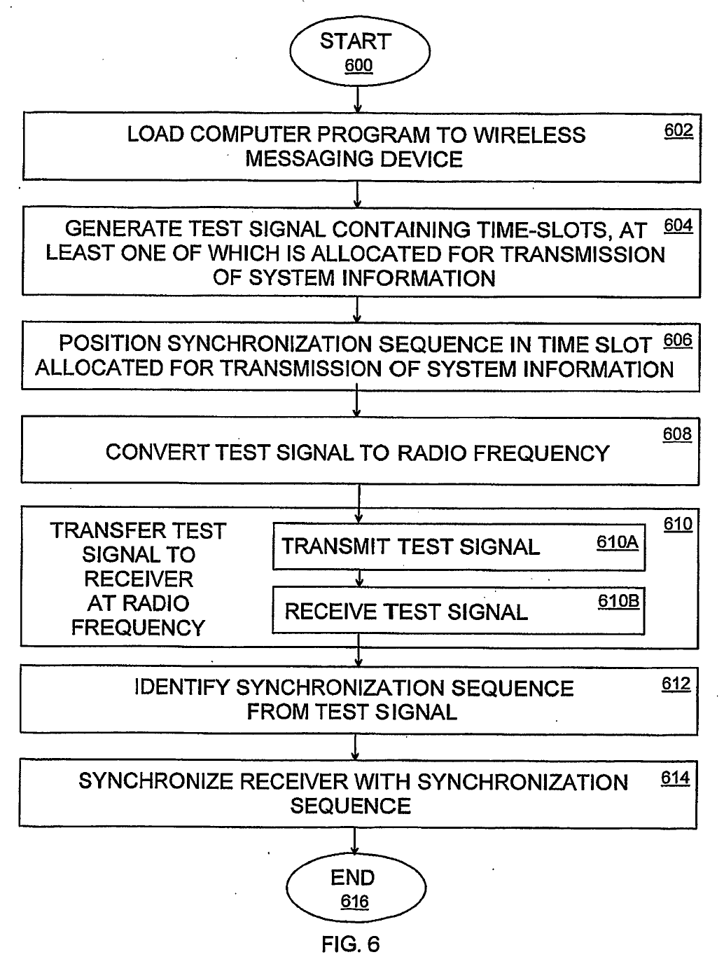

With reference to FIGS. 6, 7 and 8, different embodiments of the invention are examined as flow chart presentations.

With reference to FIG. 6, the method starts at 600.

In step 602, a computer program is loaded to a wireless messaging device, which executes a computer process comprising the steps of:

receiving a test signal as input;

identifying a synchronization sequence from the test signal; and

synchronizing the receiver by means of the synchronization sequence.

In step 604, a test signal is generated which contains physical time-slots, at least one of which is allocated for transmission of system information from a base transceiver station of the mobile communication system to the messaging device.

In step 606, the synchronization sequence supported by the mobile communication system is positioned in a time-slot allocated for transmission of system information.

In step 608, the test signal is converted to radio frequency.

In step 610, the test signal is transmitted at radio frequency to the receiver. The method step 610 includes step 610A in which a test signal is transmitted, and step 610B in which the test signal is received as input, the test signal containing physical time-slots, at least one of which time-slots is allocated for transmission of system information from a base transceiver station of the mobile communication system to the messaging device, and a synchronization sequence being positioned in this time-slot.

In step 612, the synchronization sequence is identified from the test signal.

In step 614, the receiver is synchronized by mean of the synchronization sequence.

In step 616, the method ends.

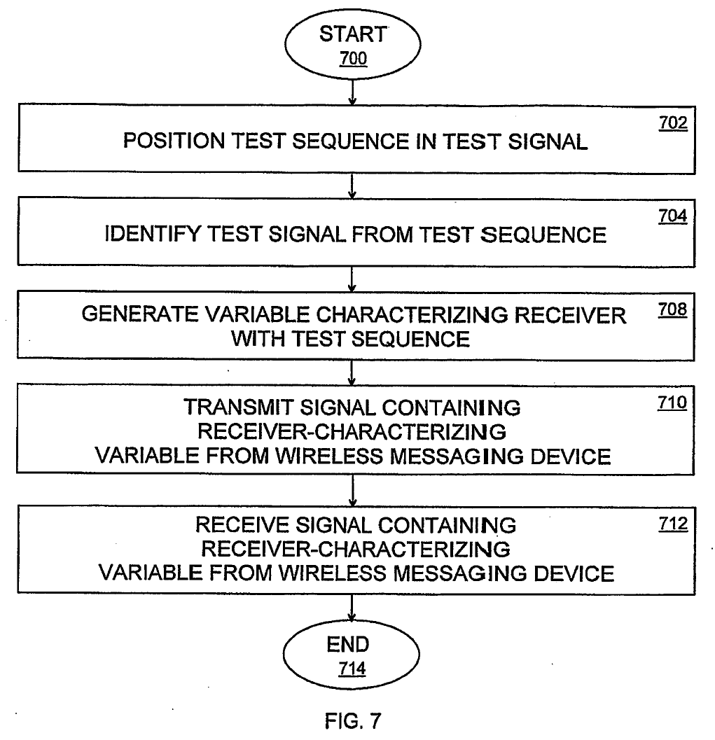

With reference to FIG. 7, the method starts at 700.

In step 702, a test sequence is positioned in a test signal.

In step 704, the test signal is received.

In step 704, the test sequence is identified from the test signal.

In step 708, a variable characterizing the receiver is generated by means of the test sequence.

In step 710, a signal containing the receiver-characterizing variable is transmitted from the wireless messaging device.

In step 712, the signal containing the receiver-characterizing variable is received from the wireless messaging device.

In step 714, the method ends.

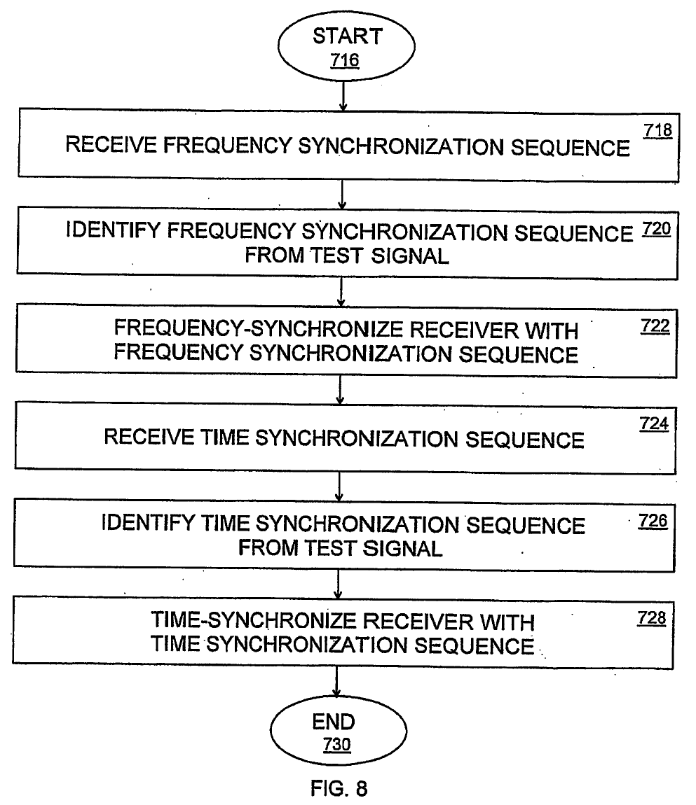

With reference to FIG. 8, the method starts at 716.

In step 718, a test signal is received as input, a frequency synchronization sequence being positioned in at least one of its time-slots allocated for transmission of system information.

In step 720, the frequency synchronization sequence is identified from the test signal.

In step 722, the receiver is frequency-synchronized by means of the frequency synchronization sequence.

In step 724, a test signal is received as input, a time synchronization sequence being positioned in at least one of its time-slots allocated for transmission of system information.

In step 726, the time synchronization sequence is identified from the test signal.

In step 728, the receiver is time-synchronized by means of the time-synchronization sequence.

In step 730, the method ends.

The invention also relates to a computer program which is loaded from a test system to a wireless communication device. The embodiments of the computer process executed by the computer program become apparent from the flow charts of FIGS. 6, 7 and 8.

The computer program may be stored in storing means, such as a CD (Compact Disk), hard disk, diskette or portable memory unit. The computer program may also be transferred by means of a signal which can be transmitted in an information network, such as the Internet.

Although the invention is described above with reference to the example according to the attached drawings, it is obvious that the invention is not limited thereto but can be modified in a plurality of ways within the scope of the attached claims.

What is claimed is:

1. A method for testing a receiver of a wireless messaging device in a mobile communication system, comprising:
generating, in a production stage of the wireless messaging device a test signal which contains physical time-slots, at least one of which is allocated for transmission of system information from a base transceiver station of the mobile communication system to the messaging device; and
positioning a synchronization sequence supported by the mobile communication system in a time-slot allocated for transmission of system information.

2. A method according to claim 1 further comprising:
converting the test signal to radio frequency; and
transmitting the test signal to the receiver at the radio frequency.

3. A method according to claim 1, wherein positioning comprises positioning a frequency synchronization sequence supported by the mobile communication system in a time-slot allocated for transmission of system information, the method further comprising:
identifying the frequency synchronization sequence from the test signal; and
frequency-synchronizing the receiver by means of the frequency synchronization sequence.

4. A method according to claim 1, wherein positioning comprises positioning a time synchronization sequence supported by the mobile communication system in a time-slot allocated for transmission of system information, the method further comprising:
identifying the time synchronization sequence from the test signal; and
time-synchronizing the receiver by means of the time synchronization sequence.

5. A method according to claim 1, wherein positioning comprises:
positioning a frequency synchronization sequence supported by the mobile communication system in the first time-slot allocated for transmission of system information; and
positioning a time synchronization sequence supported by the mobile communication system in the second time-slot allocated for transmission of system information in such a way that the interval between the front edge of the first time-slot and the front edge of the second time-slot is 8 time-slots.

6. A method according to claim 1, wherein generating comprises generating a test signal containing a 51-frame multi-frame, which has a plurality of time-slots allocated for transmission of system information, and positioning comprises positioning synchronization sequences supported by the mobile communication system in time-slots allocated for transmission of system information in such a way that the synchronization sequence is repeated at least 11 times in the 51-frame multi-frame.

7. A method according to claim 1, further comprising:
positioning a test sequence in the test signal;
receiving the test signal;
identifying the test sequence from the test signal;
generating a variable characterizing the receiver by means of the test sequence;
transmitting a signal containing the receiver-characterizing variable from the wireless messaging device; and
receiving the signal containing the receiver-characterizing variable from the wireless messaging device.

8. A method according to claim 1, wherein positioning comprises positioning a synchronization sequence supported by the mobile communication system in a time-slot allocated for transmission of system information, which synchronization sequence contains at least one of the following: the training sequence code of a synchronization channel according to the GSM standard; bits of a frequency correction channel according to the GSM standard.

9. A method according to claim 1, further comprising transmitting the test signal to the receiver via an antenna connection of the receiver.

10. A method according to claim 1, further comprising loading to the wireless messaging device a computer program which executes a computer process comprising:
receiving the test signal as input;
identifying the synchronization sequence from the test signal; and
synchronizing the receiver by means of the synchronization sequence.

11. A method according to claim 1, further comprising identifying the synchronization sequence from the test signal; and
synchronizing the receiver by means of the synchronization sequence.

12. A system for testing a receiver of a wireless messaging device of a mobile communication system, comprising:
a test-signal generator for generating a test signal in a production stage of the wireless messaging device, which test signal contains physical time-slots, at least one of which time-slots is allocated for transmission of system information from a base transceiver station of the mobile communication system to the messaging device, the test-signal generator being configured to position a synchronization sequence supported by the mobile communication system in a time-slot allocated for the transmission of system information.

13. A system according to claim 12, further comprising:
conversion means connected to the test-signal generator for converting the test signal to radio frequency; and
transmission means connected to conversion means for transmitting the test signal to the receiver at the radio frequency.

14. A system according to claim 13, wherein the transmission means are connected to an antenna connector of the wireless messaging device.

15. A system according to claim 12, wherein the test-signal generator is configured to position one of the following in a time-slot allocated for transmission of system information: a time synchronization sequence supported by the mobile communication system, a frequency synchronization sequence supported by the mobile communication system.

16. A system according to claim 12, wherein the test-signal generator is configured to position a frequency synchronization sequence supported by the mobile communication system in the first time-slot allocated for transmission of system information, the test-signal generator being further configured to position a time synchronization sequence supported by the mobile communication system in the second time-slot allocated for transmission of system information in such a way that the interval between the front edge of the first time-slot and the front edge of the second time-slot is 8 time-slots.

17. A system according to claim 12, wherein the test-signal generator is configured to generate a test signal containing a 51-frame multi-frame, which has a plurality of time-slots allocated for transmission of system information, the test-signal generator is being further configured to position synchronization sequences supported by the mobile communication system in time-slots allocated for transmission of system information in such a way that the synchronization sequence is repeated at least 11 times in the 51-frame multi-frame.

18. A system according to claim 12, wherein the test-signal generator is configured to position in the test signal a test sequence, of which the receiver generates a variable characterizing the receiver.

19. A system according to claim 12, wherein the test-signal generator is configured to position a synchronization sequence supported by the mobile communication system in a time-slot allocated for transmission of system information, which synchronization sequence contains at least one of the following: the training sequence code of a synchronization channel according to the GSM standard; bits of a frequency correction channel according to the GSM standard.

20. A system according to claim 12, wherein the system further comprises a connection unit for receiving from the wireless messaging device a signal that contains a variable characterizing the receiver.

21. A system according to claim 12, further comprising a loading unit for loading a computer program to the wireless messaging device, which computer program executes a computer process comprising the steps of:
receiving the test signal as input;
identifying the synchronization sequence from the test signal; and
synchronizing the receiver by means of the synchronization sequence.

22. A computer program for executing a computer process for testing a receiver of a wireless messaging device of a mobile communication system, the computer process comprising:
receiving, in a production stage of the wireless messaging device, as input a test signal containing physical time-slots, at least one of which is allocated for transmission of system information from a base transceiver station of the mobile communication system to the messaging device, a synchronization sequence supported by the mobile communication system being positioned in this time-slot;
identifying the synchronization sequence from the test signal; and
synchronizing the receiver by means of the synchronization sequence.

23. A computer program according to claim 22, wherein the computer process comprises:
receiving the test signal as input, a frequency synchronization sequence being positioned in at least one of its time-slots allocated for transmission of system information;
identifying the frequency synchronization sequence from the test signal; and
frequency-synchronizing the receiver by means of the frequency synchronization sequence.

24. A computer program according to claim 22, wherein the computer process comprises:
receiving the test signal as input, a time synchronization sequence being positioned in at least one of its time-slots allocated for transmission of system information;
identifying the time synchronization sequence from the test signal; and
time-synchronizing the receiver by means of the time-synchronization sequence.

25. A computer program according to claim 22, wherein the computer process comprises:
receiving as input a test signal which contains a 51-frame multi-frame with a plurality of time-slots allocated for transmission of system information, synchronization sequences supported by the mobile communication system being positioned in time-slots in such a way that repetition of the synchronization sequence in the 51-frame multi-frame is at least one of the following: 7 times, 11 times; and
synchronizing the receiver by means of the synchronization sequences.

26. A computer program according to claim 22, wherein the computer process comprises:
receiving as input the test signal that contains a test sequence;
identifying the test sequence from the test signal;
generating a variable characterizing the receiver by means of the test sequence; and
outputting the signal containing the receiver-characterizing variable to an external bus of the wireless messaging device.

27. A computer program according to claim 22, wherein the computer process comprises receiving as input the test signal that contains physical time-slots, at least one of which time-slots is allocated for transmission of system information from the base transceiver station to the messaging device, and in which time-slot a synchronization sequence supported by the mobile communication system is positioned, the synchronization sequence comprising at least one of the following: the training sequence code of a synchronization channel according to the GSM standard; bits of a frequency correction channel according to the GSM standard.
